(19) United States
(12) Patent Application Publication
(10) Pub. No.: US 2008/0199322 A1
(43) Pub. Date: Aug. 21, 2008

(54) Method And Apparatus For Pumping Out The Liquid In A Container

(75) Inventor: Tetsuo Yamane, Takatsuki-Cho (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KEISHIN SOBI KABUSHIKI KAISHA HEISHIN SOBI KABUSHIKI KAISHA, Kobe-shi (JP)

(21) Appl. No.: 11/915,496

(22) PCT Filed: Apr. 24, 2006
(86) PCT No.: PCT/JP2006/308513

§ 371 Date: Mar. 10, 2008

(30) Foreign Application Priority Data
May 26, 2005 (JP) 2005-153890

(51) Int. Cl. F04B 15/02; F17D 1/14

(52) U.S. Cl. 417/53; 137/1; 137/565.01

(57) ABSTRACT

Problems

To provide a method for pumping out the liquid in a container easily without any skill, and without liquid leaking between the inner peripheral surface of the container and the seal around a follow plate even if the sealing force of the seal is weakened.

Solving Means

A method for pumping out the low-viscosity liquid T in a container P such as a pail includes the steps of inserting a follow plate 10 into the container P, lowering the follow plate 10 by means of a lift, with the seal around the follow plate 10 in contact with the inner peripheral surface of the container P, and driving a pump 2, with the follow plate 10 seated on the surface of the liquid and kept moving downward. The downward load created by the weight of the follow plate 10 and the load of the pump 2 is substantially balanced with the upward load exerted by a spring balancer 38. This reduces the sealing force of the seal 15 around the follow plate 10 against the inner peripheral surface of the container P so that the plate 10 can be lowered according to the amount of liquid pumped out by the self-sucking force of the pump 2.

### FIELD OF THE INVENTION

The present invention relates to a method and an apparatus for pumping out the liquid contained in a drum, a pail, or another container, by pumping up and discharging the liquid, with a follow plate in airtight contact with the inner peripheral surface of the container. The liquid ranges between high-viscosity liquid and low-viscosity liquid that borders on water. The high-viscosity liquid may be food material, printing ink, sealant, or putty. The food material may be tomato paste or cream.

### BACKGROUND OF THE INVENTION

In general, a method for pumping out the liquid contained in a container open at its top includes mounting a pumping apparatus on a lift for vertically moving the follow plate fitted to a pump, seating the follow plate on the liquid surface in the container, and pumping out the liquid, with the follow plate moving downward with the liquid surface. In general, an apparatus for pumping out the liquid contained in a container open at its top is mounted on a lift for vertically moving the follow plate fitted to a pump. The follow plate can be seated on the liquid surface in the container. The liquid can be pumped out with the seated follow plate moving downward with the liquid surface. Whether the lift moves the follow plate manually or automatically (by an electric motor, an air cylinder, or a hydraulic cylinder), the liquid can be pumped out either with the pump and the follow plate exerting all loads on the liquid surface, or with additional pressure applied on the liquid surface if the liquid is high in viscosity. The follow plate is surrounded by a seal, which may be a rubber ring in the form of a plate, an expandable rubber tube, or another structure, as will be described later on. At least while the liquid is pumped out, the follow plate is lowered with the seal pressed strongly against the inner peripheral surface of the container.

While the pump is pumping out the liquid, the follow plate isolates the inside of the container from the outside (atmosphere), and the pumping action makes the space under the follow plate in the container negative in pressure. When the inside of the container is negative in pressure, the atmospheric pressure presses the follow plate, so that a downward pressure acts on this plate. If the differential pressure is 80 kPa, for example, that for a pail is about 5.1 kN (520 kgf). The load of the pump etc. are further added. Therefore, conventionally, the seal (made generally of rubber) surrounding a follow plate, as stated above, is pressed strongly against the inner peripheral surface of a container so as to prevent liquid leakage. If the follow plate becomes eccentric with respect to the inner peripheral surface of the container, liquid leakage may occur. This makes it necessary to position the container accurately and carefully relative to the follow plate (so that the container can be concentric with the plate).

For example, FIG. 4 shows a follow plate 71 for use in a pumping apparatus of this type. With reference to FIG. 4, an annular rubber ring 72 in the form of a plate is fitted to the outer periphery of the follow plate 71. The outer diameter of the rubber ring 72 is slightly larger than the inner diameter of a container P such as a drum. When the follow plate 71 is inserted into the container P, the air release port 73 is opened for air release. When the follow plate 71 is seated on the liquid T in the container P, the liquid may leak through the air release port 73 and splash, making the environment dirty. This makes it necessary to insert the follow plate 71 carefully into the container P. An on-off valve 74 is connected to the air release port 73. The air release port 73 needs to be closed by operating the on-off valve 74, with the follow plate 71 seated on the liquid T in the container P. The operation is troublesome because it is impossible to observe from the outside of the container P how the follow plate 71 is seated on the liquid T. When the follow plate 71 on the bottom of the container P is lifted, the rubber ring 72 is deformed in close contact with the container, so that the container might be lifted. In order to prevent the container P from being lifted, it is preferable to form an air supply port 75, from which compressed air can be purged through an air injection adaptor 76 so that compressed air can be supplied into the container P. In FIG. 4, reference numeral 2′ indicates a pump body.

FIG. 5 shows a follow plate 81 having another structure, which is surrounded by an expandable rubber tube 82. With the rubber tube 82 contracted, the follow plate 81 can be inserted into a container P. With the follow plate 81 seated on the liquid T in the container P, the rubber tube 82 can be supplied with compressed air through an air supply/release port 83 so as to be expanded. The expanded tube 82 comes into close contact with the inner peripheral surface of the container P so as to seal it. In FIG. 5, reference numeral 2′ indicates a pump body.

A follow plate unit is proposed which includes a follow plate body, two keep plates, a bottom plate 4, and an annular seal made of elastic rubber. The bottom plate is identical in form with the plate body. One of the keep plates is fitted on the upper side of the main body. The other keep plate is fitted to the bottom plate. The annular seal is fixed to the keep plates. Only when the bottom plate comes into contact with the surface of the high-viscosity liquid in a drum, the weight of a pump and downward air pressure enlarge the outer diameter of the annular seal in comparison with the plate body and the bottom plate. In the process of fitting the follow plate unit into or taking it out of the drum, the weight of the plate body stretches the annular seal downward due to the elasticity of the seal, thereby reducing the outer diameter of the seal. While the pump, which is mounted on the top of the follow plate unit, is operating, the weight of the pump and downward air pressure enlarge the outer diameter of the annular seal. (Refer to Patent Document 1, for example) Patent Document 1: JP-H8-82282A (paragraphs 0005-0007 and FIGS. 1-3)

### DISCLOSURE OF THE INVENTION

### Problems to be Solved by the Invention

In a conventional method or apparatus as described above for pumping out the liquid contained in a container, the load of a pump etc. act on a follow plate. The seal around the follow plate is strong in sealing force to prevent liquid leakage. As a result, when the follow plate is moved vertically with the pump, the sliding resistance created by the contact between the seal and the inner peripheral surface of the container is high. For a similar reason, it is difficult for the follow plate to be lowered only by the load (weight) of the pump etc. Accordingly, it is often necessary to apply downward pressure forcedly to the follow plate by means of an air cylinder, a hydraulic cylinder, or the like. As stated already, it is necessary to position the follow plate concentrically in the container in order to prevent liquid leakage. Therefore, positioning is necessary when the container is put in the pumping apparatus. The positioning may require time and skill.

The present invention has been made in view of the foregoing points. The object of the present invention is to provide a method and an apparatus for pumping out the liquid in a container easily without any skill, and without liquid leaking between the inner peripheral surface of the container and the seal around a follow plate even if the sealing force of the seal is weakened.

### Means for Solving the Problems

In order to attain the foregoing object, a method according to the present invention for pumping out the high-viscosity or low-viscosity liquid contained in a container such as a pail includes the steps of inserting a follow plate into the container, lowering the follow plate by means of a lift, and starting to drive a pump, with the follow plate seated on the surface of the contained liquid and kept moving downward, and with the seal around the follow plate in contact with the inner peripheral surface of the container, the method being characterized in:

that, in consideration of the weight of the follow plate, the load of the pump, and the sealing force of the seal which acts on the inner peripheral surface of the container, the downward load of the follow plate is substantially balanced with the upward load exerted by a balance weight or the like; and

that the sealing force of the seal around the follow plate is reduced so that the plate can be lowered according to the amount of liquid pumped out by the self-sucking force of the pump.

The method according to the present invention makes it possible to reduce the sealing force of the seal. As a result, when the follow plate moves vertically, the sliding resistance of the inner peripheral surface of the container to it is low in comparison with the conventional methods. This enables the follow plate to move upward smoothly with relatively weak lifting force. This also enables the follow plate to move downward smoothly with the reaction caused by the sucking force of the pump, without applying additional downward load. The follow plate moves downward for a distance equivalent to the amount of liquid pumped from the container mainly by the self-sucking force of the pump. This prevents liquid leakage even if the sealing force is reduced. However, the sealing force needs to be set at such a value as to prevent air from being sucked between the seal and the inner peripheral surface of the container into the container by the sucking force of the pump. For a similar reason, liquid leakage hardly occurs even if the container is slightly eccentric from the follow plate. This makes it easy to position the container relative to the follow plate.

It is preferable to, as claimed in claim 2, so set the upward load that, with the follow plate seated on the surface of the liquid contained in the container, the weight of the follow plate does not lower the plate when the pump is not driven.

This prevents liquid leakage between the seal and the inner peripheral surface of the container even when the pump is stopped.

The sealing force may, as claimed in claim 3, be set to such a degree according to the property of the contained liquid that the seal can be in contact with the inner peripheral surface of the container or scrape off the liquid sticking to the surface. If the contained liquid is a low-viscosity liquid such as water, the sealing force may be weak to such a degree that the seal is only in contact with the inner peripheral surface. If the contained liquid is a high-viscosity liquid, the sealing force may be slightly strong to such a degree that the seal can scrape off the sticking liquid.

This minimizes the sliding resistance of the inner peripheral surface of the container to the follow plate moving vertically. The minimized resistance makes the vertical movement of the follow plate easy and smooth.

In order to attain the foregoing object, an apparatus according to the present invention for pumping out the liquid contained in a cylindrical or rectangular container open at the top thereof includes a circular or rectangular follow plate fitted around the suction port at the bottom of a pump, the apparatus being adapted to suck and pump out the contained liquid by driving the pump, with the follow plate inserted into the container and being lowered by a lift, the apparatus being characterized in:

that, in consideration of the weight of the follow plate, the load of the pump, and the sealing force of the seal which acts on the inner peripheral surface of the container, a balance weight is so fitted that an upward load for substantially balancing the downward load of the follow plate can act on the plate; and

that the sealing force of the seal around the follow plate is set to such a degree according to the property of the contained liquid that the seal can be in contact with the inner peripheral surface of the container or scrape off the liquid sticking to the surface.

The follow plate may be lifted and lowered manually. In this case, particularly, the follow plate can be lifted easily with weak force. Alternatively, the follow plate may be lifted and lowered by a hydraulic drive, an electric drive, or another drive. In this case, the follow plate can be lifted and lowered with weak driving force, so that it is easy to make the apparatus small in size. In this case, the follow plate can be lifted and lowered smoothly at higher operating efficiency.

### BEST MODE OF CARRYING OUT THE INVENTION

The best mode of pumping apparatus implementing a pumping method according to the present invention will be described below with reference to the drawings.

FIG. 1(a) is a side view of a pumping apparatus according to an embodiment of the present invention, showing the apparatus having not yet started to pump out the (low-viscosity) liquid contained in a container. FIG. 1(b) is a front view of the pumping apparatus, showing the apparatus pumping out the (low-viscosity) liquid in the container. FIG. 1(c) is a perspective view of a constant force spring.

In these figures, the pumping apparatus 1 includes a vertical uniaxial eccentric screw pump 2 as a main component. The main body 3 of the pump 2 is joined to the bottom of a pump casing 4. As shown in FIG. 3, which will be described later on, the pump body 3 consists of a female thread type stator 5 and a male thread type rotor 6. The stator 5 has a bore elliptic in cross section and twice as long as the rotor 6 in pitch. The rotor 6 is circular in cross section and positioned rotatably in the stator 5. A speed reducer 7 is joined to the top of the pump casing 4. A rotating shaft (not shown) extends downward from the speed reducer 7. The rotor 6 is coupled to the rotating shaft by a flexible rod 8. Because the rotation axis of the rotor 6 is eccentric from the axis of the rotating shaft, the flexible rod 8 or a flexible wire is used so that the rotor 6 can eccentrically rotate. The pump casing 4 has a discharge port 4a formed near its top for connection to a transfer hose (not shown). In this embodiment, the uniaxial eccentric screw pump 2 consists of the pump body 3 (pump casing 4, stator 5, and rotor 6), the speed reducer 7, and an electric motor 9, which is mounted on the top of the reducer 7. The driving shaft (not shown) of the motor 9 is coupled directly to the rotating shaft.

A follow plate 10, which will be described later on, is fitted removably around the suction port 2a formed at the bottom of the stator 5. In this embodiment, the follow plate 10 includes a rigid disk 10A and a seal 15 in the form of a rubber plate, which is fitted around the disk 10A. The outer diameter of the follow plate 10 is such that this plate can be inserted into a cylindrical container (for example, a pail) P open at its top. In this embodiment, the sealing force against the inner peripheral surface of the container P is preset according to the property of the liquid contained in the container.

FIG. 3(a) is an enlarged central vertical section of the follow plate and pump body, showing an adjustable follow plate. FIG. 3(a) shows, on the right, the follow plate and the pump body being put into the container P, with the seal diameter reduced. FIG. 3(a) shows, on the left, the pumping apparatus pumping out the liquid in the container P, with the seal diameter enlarged. FIG. 3(b) is a view of part of FIG. 3(a) as seen in the direction F. FIG. 3(c) is a partial perspective view showing a ring piece of a pressing ring 12 being out of engagement with a notch of an annulus 11.

In this embodiment, as shown in FIG. 3(a), the follow plate 10 used in the pumping apparatus 1 is circular in plan view and has a circular opening 10a formed through its center for connection to the suction port 2a of the pump 2. The follow plate 10 includes a metallic rigid plate 10b, which has a lower peripheral step 10c formed at its edge. The metallic annulus 11, which is constant in diameter, is engaged removably with the inner periphery of the peripheral step 10c. The annulus 11 has notches 11a formed at circumferential intervals. As shown in FIG. 3(c), the circular pressing ring 12 has guides 12a protruding inward from it and surrounds the annulus 11 vertically slidably, with each guide 12a protruding inward through one of the notches 11a. Pairs of supports 13 stand on the follow plate 10 at circumferential intervals inside the annulus 11. The guide 12a at each notch 11a is positioned between the supports 13 of one pair. Each support 13 has a vertical slot 13a. An eccentric cam 17 includes a circular eccentric cam part 17a having a through hole 17b. A shaft 14 extends through the hole 17b and engages with the slots 13a of each pair of supports 13. An eccentric lever 17 is so fitted that it can turn eccentrically up and down. The eccentric cam part 17a of the eccentric lever 17 is in contact with each guide 12a.

The turning of the eccentric lever 17 in a specified direction presses down the pressing ring 12. The seal 15, which is a rubber tube in the form of a ring, is fitted between the pressing ring 12 and the peripheral step 10c of the follow plate 10. By varying the turning angle of the eccentric lever 17, it is possible to adjust the degree to which the seal 15 swells, that is, the sealing force. The eccentric lever 17 is normally held in the position for the largest amount of eccentricity. As shown in FIG. 3(b), each support 13 has a tapped hole 19 formed in an upper end portion of it. A bolt 16 engages with the tapped hole 19 and adjusts the vertical position of the associated shaft 14, around which the eccentric lever 17 turns. The bottom of the bolt 16 is in contact with the shaft 14. By turning the bolt 16 relative to a nut 18, it is possible to adjust the vertical position of the shaft 14. If the poison of the shaft 14 lowers, the pressing ring 12 strongly presses the seal 15, so that the sealing force becomes stronger. If the position of the shaft 14 rises, the sealing force of the seal 15 becomes weaker. In FIG. 3(a), numeral 21 indicates an air supply hole.

As shown in FIG. 1, the uniaxial eccentric screw pump 2 is so supported that it can move vertically along a pair of struts 31 standing on a base 33, which has casters 32. A vertical slide rail 34 extends axially on the front side of each strut 31. A slide plate 35 is so fitted that it can move vertically along the slide rails 34 on the struts 31. The bottom of the speed reducer 7 of the pump 2 is connected to a lifting unit 37 in the form of a box by a right-angled-triangular bracket 36. A constant force spring 38 (for example, CONSTON (trademark) of Sanko Spring K. K.) as shown in FIG. 1(c) has an upper drum shaft 38a and a lower drum shaft 38b, which are fitted in the lifting unit 37. The upper drum shaft 38a rotates with a drum 39, on which a balance wire 40 is wound with its one end fixed to the drum 39. The other end of the balance wire 40 is passed over a pulley 41 and fixed to a top plate 42 between the struts 31. Under this condition, the constant force spring 38 substantially cancels the weight (downward load) of the uniaxial eccentric screw pump 2 (pump body 3 (pump casing 4, stator 5 and rotor 6), speed reducer 7 and electric motor 9) and follow plate 10, so that a slight downward load is exerted.

Sprockets 43 and 44 are supported rotatably over and under the slide rails 34 on the struts 31. A chain 45 is in mesh with the sprockets 43 and 44. Both ends of the chain 45 are wound by some turns on the drum 39 of a lifting handle 46 and connected to it. As shown in FIG. 1(a), the slide plate 35 is connected to the chain 45 by a connector 47 so that this plate can move vertically with the chain.

In this embodiment, the turning of the lifting handle 46 moves the follow plate 10 vertically with the chain 45. Because the weight of the pump 2 etc. hardly acts on the follow plate 10, the handle 46 can be turned with slight force. If the follow plate 10 is lowered to the level of liquid T in the container P when the liquid is pumped out, the follow plate 10 is seated as if it floated on the liquid T even if the operator releases the handle 46. Then, if the electric motor 9 is activated to rotate the rotor 6 of the pump 2, the liquid T in the container P is pumped out by self-sucking force, so that the follow plate 10 moves downward. This makes the chain 45 run to automatically turn the handle 46. If the viscosity of the liquid T is low, the sealing force of the seal 15 around the follow plate 10 should be so adjusted as to be weak to such a degree that the seal is only in contact with the inner peripheral surface of the container P. In this case, as the liquid T is pumped out of the container P, the follow plate 10 moves downward without the liquid T leaking out between the seal 15 and the inner peripheral surface of the container P.

If the viscosity of the liquid T is high, the sealing force of the seal 15 around the follow plate 10 should be so adjusted as to be slightly strong to such a degree that the seal 15 scrapes off the liquid T sticking to the inner peripheral surface of the container P. This adjustment can, in the structure of the follow plate 10 shown in FIG. 3, be made by lowering the vertical position of the shaft 14 of the eccentric lever 17 in the slots 13a by means of the bolts 16, and by subsequently turning the lever 17 to enlarge the seal 15 in diameter. If the electric motor 9 is activated to rotate the rotor 6 of the pump 2, the liquid T in the container P is pumped out by self-sucking force, so that the follow plate 10 moves downward with the seal 15 scraping away the liquid T sticking to the inner peripheral surface of the container P. In this case, the sealing force is set at a slightly stronger value than for the low-viscosity liquid. Therefore, it is preferable to select a constant force spring 38 (FIG. 1(c)) slightly weak in spring force so as to increase the downward load acting on the follow plate 10. In this case, air hardly flows between the seal 15 and the inner peripheral surface of the container P into the container. Therefore, it is also preferable to form the air supply hole 21, which is fitted with an air supply pipe (not shown) and an on-off valve (refer to FIG. 4), through the follow plate 10, and to open the on-off valve in order to supply air so that the follow plate 10 can be lifted after the liquid T is pumped out. However, in this case also, because the constant force spring 38 reduces the weight of parts including the follow plate 10 in comparison with the conventional pumping apparatus, it is possible to lift the follow plate 10 by turning the lifting handle 46 with relatively weak force.

An embodiment of the follow plate of the present invention has been described hereinbefore. The present invention can be embodied as follows.

The handle 46 might be replaced by a lifting motor (not shown) with a brake. The lifting motor might be fitted to the struts 31. The driving shaft of the lifting motor might be coupled directly to a shaft supported in the position where the handle 46 would otherwise be fitted, or to the shaft of the upper sprocket 43 so as to drive the chain 45.

As shown in FIG. 2, a slide plate 35 moves vertically along the slide rails 34 of a pair of struts 31 and carries an electric motor 9, a uniaxial eccentric screw pump 2, and a follow plate 10. One end of a balance wire 40 is fixed to the slide plate 35. The balance wire 40 is passed over a pulley 41, which is supported on the top plate 42 between the tops of the struts 31. The other end of the balance wire 40 is fixed to a counter weight 48 for balancing. The weight of the counter weight 48 is equivalent to the load of the motor 9, pump 2, and follow plate 10. An air cylinder 50 is fitted in the struts 31. The piston rod 51 of the air cylinder 50 extends downward. The front end of the piston rod 51 is connected to the slide plate 35. The air cylinder 50 can move the slide plate 35 with the follow plate 10 vertically along the slide rails 34 of the struts 31. Different counter weights 48 are provided in advance, which differ in weight by 5 kg from one another, and one of them is selected for the sealing force of the seal 15 that is set according to the property of the contained liquid T. The parts in FIG. 2 that are equivalent or similar to the counterparts in FIG. 1 are indicated by the same reference numerals, without being described.

The circular follow plate 10 might be elliptic or square according to the shape of the container P.

In each of the embodiments described above, the follow plate 10 is fitted removably to the bottom of the vertical uniaxial eccentric screw pump 2. However, the type of pump is not limited, but the pump 2 might be a rotary pump or a plunger pump.

### BRIEF DESCRIPTION OF THE DRAWINGS

FIG. 1(a) is a side view of a pumping apparatus according to an embodiment of the present invention, showing the apparatus having not yet started to pump out the (low-viscosity) liquid contained in a container. FIG. 1(b) is a front view of the pumping apparatus, showing the apparatus pumping out the (low-viscosity) liquid in the container. FIG. 1(c) is a perspective view of a constant force spring.

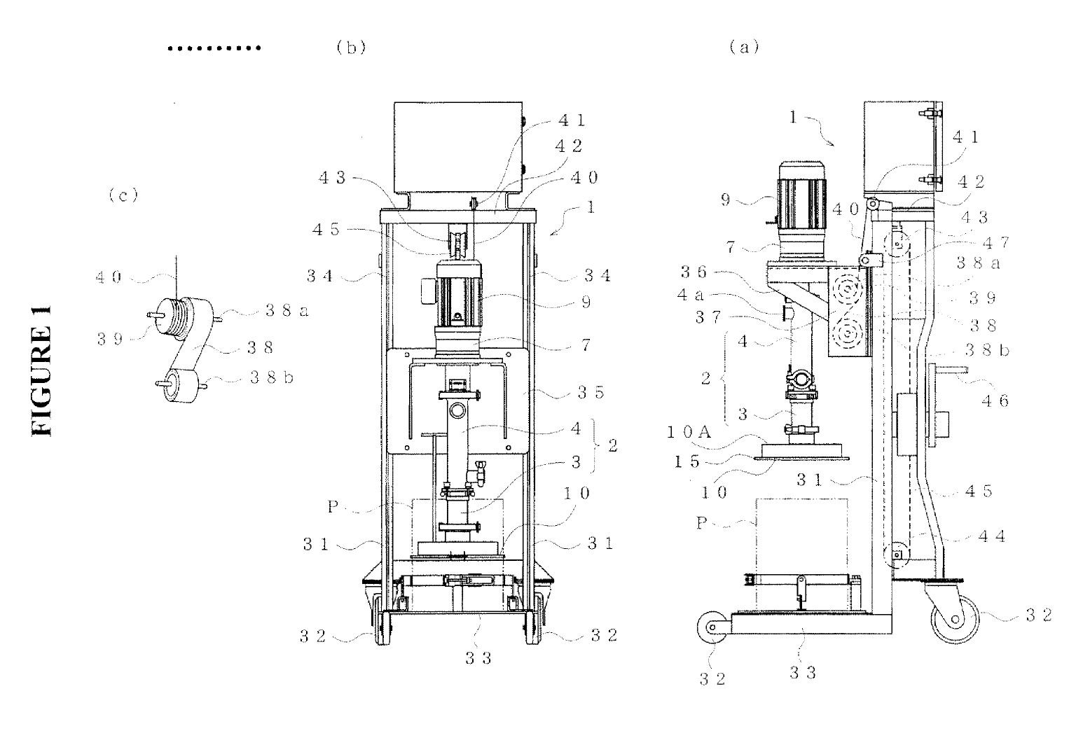

FIGS. 2(a) and 2(b) are a side view and a front view respectively of a pumping apparatus according to another embodiment of the present invention, each showing the apparatus having pumped out the liquid contained in a container.

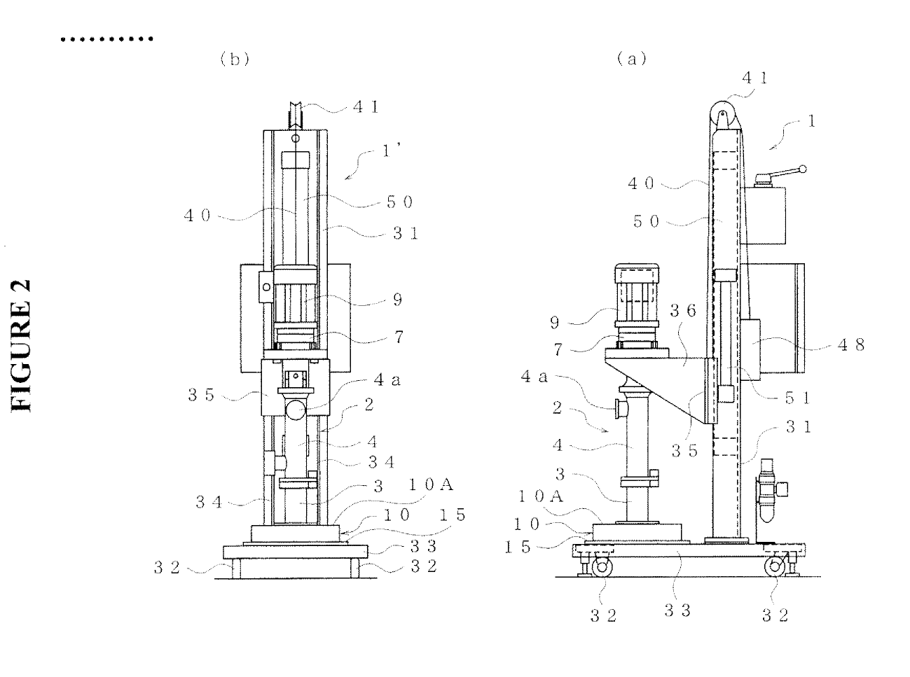

FIG. 3(a) is an enlarged central vertical section of the follow plate and pump body, showing an adjustable follow plate. FIG. 3(a) shows, on the right, the follow plate and the pump body being put into the container P, with the seal diameter reduced. FIG. 3(a) shows, on the left, the pumping apparatus pumping out the liquid in the container P, with the seal diameter enlarged. FIG. 3(b) is a view of part of FIG. 3(a) as seen in the direction F. FIG. 3(c) is a partial perspective view showing a ring piece of a pressing ring 12 being out of engagement with a notch of an annulus 11.

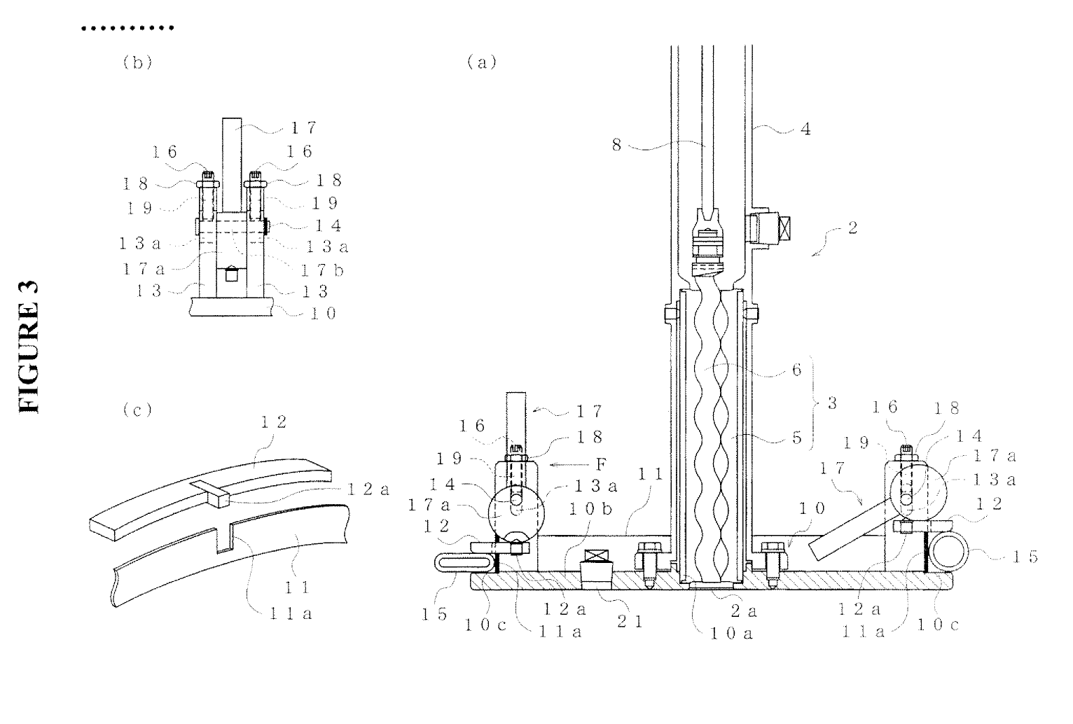

FIG. 4 is an enlarged sectional view of a conventional follow plate.

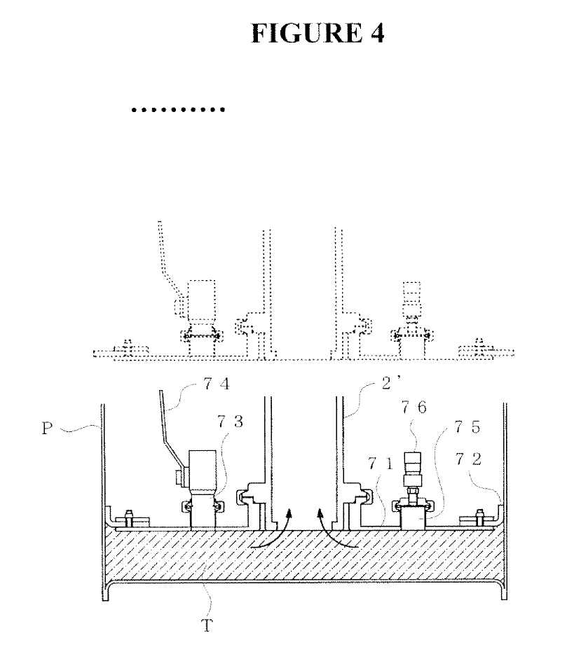

FIG. 5 is an enlarged sectional view of another conventional follow plate.

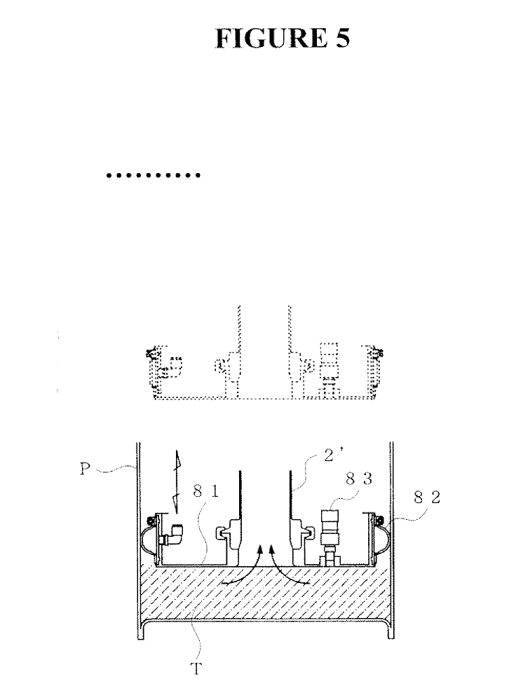

### REFERENCE NUMERALS

1 pumping apparatus

2 vertical uniaxial eccentric screw pump

3 pump body

4 pump casing

5 stator

6 rotor

7 speed reducer

8 flexible rod

9 electric motor (for pump activation)

10 follow plate

10a circular opening

10b rigid plate

10c lower peripheral step

11 annulus

11a notch

12 pressing ring

12a guide

13 support

14 shaft

17 eccentric lever

17a eccentric cam part

31 strut

32 caster

34 slide rail

35 slide plate

36 bracket

37 lifting unit

38 constant force spring (CONSTON (trademark))

39 drum

40 balance wire

41 pulley

43, 44 sprockets

45 chain

46 lifting handle

48 counter weight

50 air cylinder

51 piston rod

1. A method for pumping out a high-viscosity or low-viscosity liquid in a container by inserting a follow plate into the container, lowering the follow plate by means of a lift, starting to drive a pump, with the follow plate seated on a surface of the liquid and kept moving downward, and with a seal around the follow plate in contact with an inner peripheral surface of the container, the method being characterized in:
that, in consideration of the weight of the follow plate, the load of the pump, and the sealing force of the seal which acts on the inner peripheral surface of the container, a downward load of the follow plate is substantially balanced with an upward load exerted by a balance weight; and
that the sealing force of the seal around the follow plate is reduced so that the plate can be lowered according to the amount of liquid pumped out by a self-sucking force of the pump.

2. A method as claimed in claim 1, characterized in that the upward load is so set that, with the follow plate seated on the surface of the liquid in the container, the weight of the follow plate does not lower the plate when the pump is not driven.

3. A method as claimed in claim 1, characterized in that the sealing force is set to such a degree according to a property of the liquid in the container that the seal can be in contact with the inner peripheral surface of the container or scrape off the liquid sticking to the surface.

4. An apparatus for pumping out a liquid in a cylindrical or rectangular container open at a top thereof, the apparatus including a circular or rectangular follow plate fitted around a suction port at a bottom of a pump, the apparatus being adapted to suck and pump up the liquid from the container by driving the pump, with the follow plate inserted into the container and being lowered by a lift, the apparatus being characterized in:
that, in consideration of the weight of the follow plate, the load of the pump, and a sealing force of the seal which acts on an inner peripheral surface of the container, a balance weight is so fitted that an upward load for substantially balancing the downward load of the follow plate can act on the plate; and
that the sealing force of the seal around the follow plate is set to such a degree according to a property of the liquid in the container that the seal can be in contact with the inner peripheral surface of the container or scrape off the liquid sticking to the surface.

5. A method as claimed in claim 2, characterized in that the sealing force is set to such a degree according to a property of the liquid in the container that the seal can be in contact with the inner peripheral surface of the container or scrape off the liquid sticking to the surface.
